(19) United States
(12) Patent Application Publication
(10) Pub. No.: US 2006/0206522 A1
(43) Pub. Date: Sep. 14, 2006

(54) Electronic calendar systems and methods

(75) Inventors: Paul R. Austin, Webster, NY (US); Scott D. Weber, Canandiagua, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/078,064

(22) Filed: Mar. 11, 2005

(51) Int. Cl. G06F 17/00

(52) U.S. Cl. 707/104.1

(57) ABSTRACT

Embodiments herein use a centralized calendar database to store calendar entries for a plurality of entities. Each of the entities has a computing device separate from the centralized calendar database, and each of the computing devices has a graphic user interface. In addition, multiple calendar processors are utilized. Each calendar processor operates within an associated computing device, and each calendar processor is in communication with the centralized calendar database. The calendar processors generate a continuously updated calendar display on a corresponding graphic user interface. The actual calendar entries are stored only in the centralized calendar database, and the calendar entries are not stored locally within the computing device.

### BACKGROUND AND SUMMARY

Embodiments herein generally relate to computerized electronic calendaring and methods and systems, and more particularly to a calendaring system capable of dynamically displaying entries from multiple entities simultaneously on the same calendar.

With embodiments herein, remote computing devices are in constant communication with a centralized calendar database, which maintains all the entries for all calendars. Instead of storing individual calendars on each of the remote computing devices and performing elaborate and complicated updating procedures to keep all the individual calendars current, embodiments herein generate (and continuously dynamically regenerate) a completely new calendar on each of the remote computing devices based upon the entries stored in the centralized calendar database. This allows each entity to view a single calendar that includes the owning entities calendar entries, as well as calendar entries that are associated with a selected group of other entities. Further, because the calendar entries are only stored within the centralized calendar database, and because the calendar is being continuously dynamically regenerated by each of the remote computing devices (which are in constant communication with the centralized calendar database) the calendar display produced by embodiments herein is always current. Thus, embodiments discussed herein avoid the need for complicated and elaborate mechanisms that were conventionally required to coordinate individually maintained separate calendars.

More specifically, the electronic calendar system presented herein uses a centralized calendar database to store calendar entries for a plurality of entities. Each of the entities has a computing device separate from the centralized calendar database, and each of the computing devices has a graphic user interface. In addition, a plurality of calendar processors are utilized. Each calendar processor operates within an associated computing device, and each calendar processor is in communication with the centralized calendar database. The calendar processors generate a continuously updated calendar display on a corresponding graphic user interface. The actual calendar entries are stored only in the centralized calendar database, and the calendar entries are not stored locally within the computing device.

The calendar generator can combine calendar entries associated with two or more of the entities on a single calendar display (single calendar grid). The calendar entries can be displayed on the calendar display using different graphical representations (such as different colors, different letter sizes, different letter types, different typefaces, etc.) for calendar entries associated with different entities. Further, the calendar generator is adapted to generate “change entries” or change tracks on the calendar display. The change entries comprise an area on the calendar display were a previously scheduled calendar entry was positioned before the previously scheduled calendar entry was modified.

At least one storage device is operatively connected to each computing device and is used to maintain a combined calendar listing of entities whose calendar entries are to be combined on each calendar display. This storage device maintains a separate combined calendar listing for each of the entities, such that each calendar generator generates a unique calendar display based on each combined calendar listing on each graphic user interface.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic diagram of an exemplary electronic calendar system according to embodiments herein;

FIG. 2 is a schematic diagram of an exemplary calendar display according to embodiments herein;

FIG. 3 is a schematic diagram of an exemplary calendar display according to embodiments herein;

FIG. 4 is a schematic diagram of a menu for selecting calendars to be combined; and

FIG. 5 is a flowchart illustrating a method of generating a calendar display according to embodiments herein.

### DETAILED DESCRIPTION

The computer science fundamentals utilized with electronic calendars and the techniques to accumulate inputs, sort and maintain calendar entries into a calendar format, and other similar processing are items that are well-known to those ordinary skill in the art. To keep the reader focused upon the salient features of the invention, such fundamentals are not discussed at length herein. See, for example, U.S. Pat. No. 6,785,868; U.S. Publications 2002/0154178; 2003/0065742; 2003/0130882, 2004/0109025; 2004/0268270; and 2004/0122915, all of which are fully incorporated herein by reference.

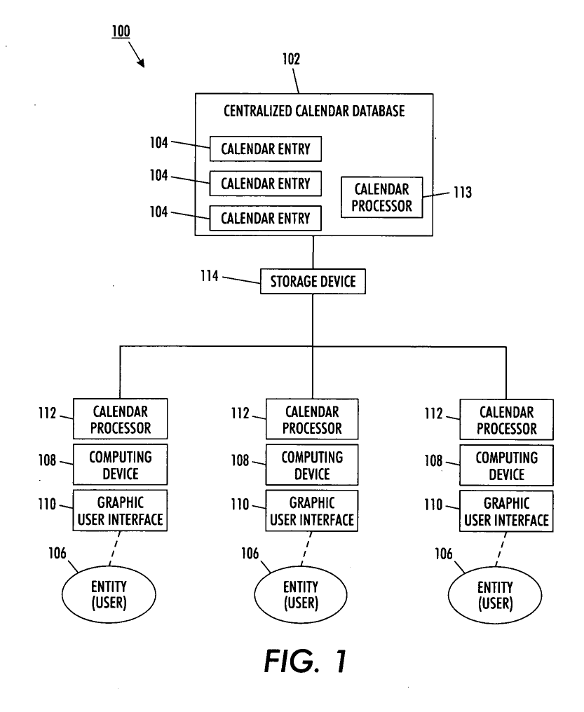

FIG. 1 illustrates an electronic calendar system 100 that uses a centralized calendar database 102 to store calendar entries 104 for a plurality of entities 106 (users). The centralized calendar database 102 can comprise any type or form of database now known or developed in the future. The entities can be individuals, groups, inanimate objects, and any type of item that could be included as having events which are properly associated with a calendar.

In the example shown in FIG. 1, each of the entities 106 is associated with a computing device 108, although as would be understood by one ordinary skill in the art, one entity 106 could utilize many computing devices 108 and many entities 106 could share a single computing device 108. The computing devices 108 can comprise any type of calculating device, such as portable digital assistants (PDAs), personal computers, portable computers, mainframe computers, computer terminals, cell phones, wristwatches, and any other type of device that has the ability to perform calculations and display a calendar. Each of the computing devices 108 can have a graphic user interface 110. The computing devices 108 are separate devices from the centralized calendar database 102 and are connected to the centralized calendar database 102 by some form of wired or wireless network including a local area network (LAN) such as an intranet, and a wide area network (WAN) such as of the Internet. While the centralized calendar database 102 is illustrated as a standalone item, it could be included within one of the computing devices 108 or a different dedicated database computing device.

In addition, one or more calendar processors 112, 113 are utilized. In the example shown in FIG. 1, each computing device 108 has a dedicated calendar processor 112; however, a single centralized calendar processor 113 (e.g., located with the centralized database 102) could be utilized in addition to or in place of the individual dedicated calendar processor units 112. Each calendar processor 112 operates within an associated computing device 108, and each calendar processor 112, 113 is in communication with the centralized calendar database 102.

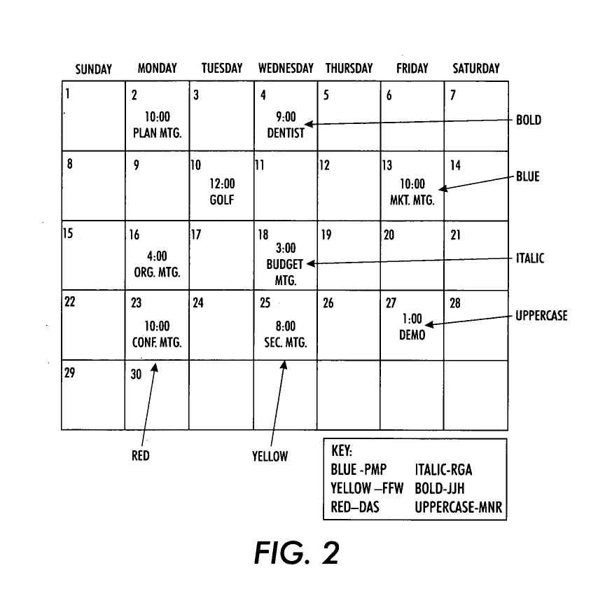

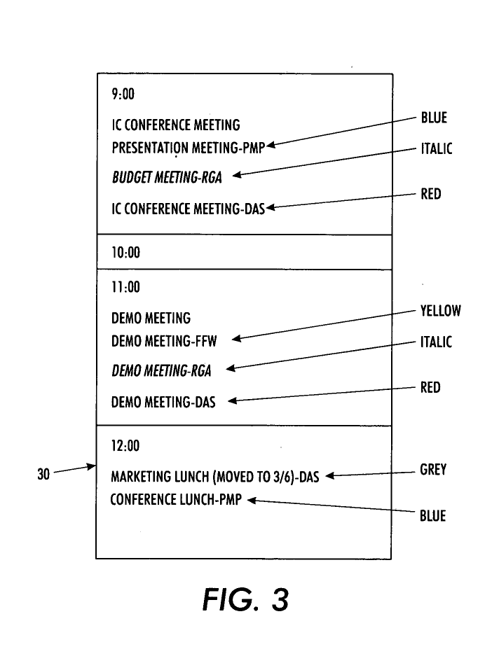

The calendar processors 112, 113 generate a calendar display on a corresponding graphic user interface 110, as shown for example in FIGS. 2 and 3. The actual calendar entries 104 are stored only in the centralized calendar database 102, and the calendar entries 104 are not stored locally within the computing device 108. Instead, only the calendar display generated by the calendar processors 112, 113 is temporarily stored within each computing device 108. Therefore, with embodiments herein, there is a single database that maintains all calendar entries 104 for many different entities 106. This structure avoids the need to continuously update calendar entries on individual computing devices 108 because the individual computing devices 108 do not store individual calendar entries 104.

Calendar events are often subject to change, sometimes with short notice. In calendar systems where copies of the event are maintained on individual computing devices, distribution of the change can be difficult, and incomplete distribution of the change frequently leads to wasted time and effort. The typical process of distributing changes, often termed “synchronization”, utilizes various communications media such as electronic mail, phone, and instant messaging. Many of these methods require manual intervention on the part of the receiving entity, so it is difficult to insure that the change has been communicated and understood. Furthermore, the typical process of synchronizing some clients against other distributed clients of calendar information creates a dependency on the order of synchronization. For example consider synchronizing a PDA's calendar with a desktop based calendar which is then subsequently synchronized with a central server or updated via email. In this situation, the changes from the central server will not reach the PDA until another subsequent synchronization. The situation is aggravated further if the PDA contains changes made locally that have not been propagated back to the desktop. This will require at least two separate synchronization before all relevant calendars contain the current information. In embodiments herein, use of the centralized event database and regeneration of the calendar at each view avoids this difficulty, since the most up to date information is presented at each request. For continuously connected devices this is ideal, providing up to date information. Further, mobile devices with intermittent connectivity will gain the benefit of synchronizing to an up-to-date calendar in one operation.

As shown in FIG. 2, the calendar processor 112, can combine calendar entries 104 associated with two or more of the entities 106 on a single calendar display (single calendar grid). The calendar entries 104 can be displayed on the calendar display using different graphical representations (such as different colors, different letter sizes, different letter types, different typefaces, etc.) for calendar entries 104 associated with different entities 106.

For example, the key at the bottom of FIG. 2 indicates that entries in blue come from an entity identified as “PMP” who could be an individual, a resource, etc. An entry on the 13th day of the month relating to a 10:00 marketing meeting is in blue indicating that this calendar entry is taken from PMP's calendar. Similarly, the calendar display shown in FIG. 2 includes a bold calendar entry on the 4th day (from entity JJH's calendar); an italic calendar entry on the 18th day (from entity RGA's calendar); a red calendar entry on the 23rd day (from entity DAS's calendar); a yellow calendar entry on the 25th day (from entity FFW's calendar); and an uppercase calendar entry on the 27th day (from entity MNR's calendar). The remaining calendar entries on the 2nd, 10th, and 16th day of the month are calendar entries of the entity who owns (or is associated with) the computing device/graphic user interface that is illustrating the calendar display, and these calendar entries could be in black-and-white or some other identifying font, color, etc.

As would be understood by one ordinarily skilled in the art in light of disclosure, the colors, fonts, etc. can be set according to the user's personal preferences. Further, as shown in FIG. 3, the entity's initials can be included within each calendar entry that is taken from a different entities calendar. As one option, all calendar entries can be shown in a single color, font, etc. with the only distinguishing characteristic being the initials that are included within the calendar entry. Further, while the drawings use three character initials to identify an entity, any length identifier (including full words or sentences) can be utilized to identify the entity's calendar from which the calendar entry was taken.

Further, the calendar generator is adapted to generate “change entries” or change tracks 30 on the calendar display, as shown in FIG. 3. Whenever an entity makes the change on the calendar display, this information is transferred from the individual computing device 108 to the centralized calendar database 102. Then, when the calendar display of the other entities (who share that entity's calendar information) is generated or regenerated, each calendar includes the revision. The change entries 30 comprise an area on the calendar display where a previously scheduled calendar entry was positioned before the previously scheduled calendar entry was modified. In other words, when an appointment on an entity's calendar is removed or changed to a different date or timeslot, the information is transferred to the new day or timeslot, and a calendar entry with some type of distinguishing characteristic (color, fonts, etc.) is left in the location of the original calendar entry. This helps notify the entities that the calendar entry has been changed, moved, canceled, etc. One peripheral advantage of manually update calendar changes is that the entity becomes aware of the change. This change tracking mechanism is intended to performs a similar role, and such changes can be featured prominently, at least initially.

Referring again to FIG. 1, at least one storage device 114 (which can be local or part of the centralized database) is operatively connected to each computing device 108, and is used to maintain a combined calendar listing of entities 106 whose calendar entries 104 are to be combined on each calendar display. The storage device 114 can be included within each of the computing devices 108, within the centralized calendar database 102, or can be a standalone item as shown in FIG. 1. This storage device 114 maintains a separate combined calendar listing for each of the entities 106, such that each calendar generator generates a unique calendar display based on each combined calendar listing on each graphic user interface 110. In other words, the storage device(s) 114 maintains a listing of which entities calendar listings are added to each of the different calendar displays.

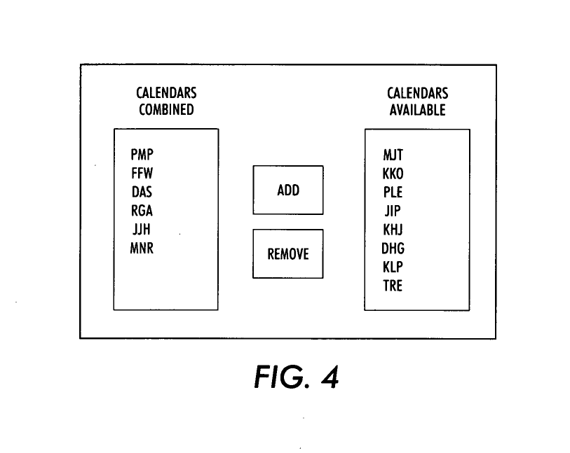

FIG. 4 is an exemplary schematic diagram of a menu for selecting calendars to be combined. In the menu shown in FIG. 4, one entity has selected the 6 “favorite” calendars shown on the left to be added to that entity's personal calendar. In addition there are 8 more calendars available on the right side of FIG. 4 that can potentially be added to that entity's calendar. The only calendars that will be included within the available of calendars list will be those calendars that the entity in question has a right to view. Because the calendar display is continuously generated (regenerated) from the data maintained within the centralized calendar database 102, and the calendar entries are not stored within the individual computing devices 108, an entity can easily add or remove another entities calendar entries to or from their personal calendar display.

In addition, the storage device(s) 114 and or computing devices 108 can be utilized to include “anti-event” or blocking calendar entries. Blocking calendar entries will prevent a certain entry from appearing on a calendar display and, from subsequently being generated (regenerated) on subsequent calendar displays. This feature is useful in helping to unclutter a calendar that may include redundant entries such as the four redundant “Demo Meeting” entries that appear at 11:00 in FIG. 3. A calendar entry can be marked as an anti-event in many different ways. For example, a pulldown or pop-up menu can provide the option to mark a calendar entry as an anti-event.

Therefore, with embodiments herein, calendar entries are not imported from one personal calendar to another personal calendar, but instead, all calendar entries are maintained within a centralized database. Then, rather than storing many calendar entries within each individual computing device 108, the calendar processor 112, 113 generates the calendar display in either a daily, monthly, yearly, etc. layout. This requires only a small amount of data (only the amount necessary to actually generate the display) be transferred to the calendar processor 112 and computing device 108. Further, whenever an entity makes a change to a calendar display, the change will appear on other entity's calendar displays as each different calendar display is generated or regenerated.

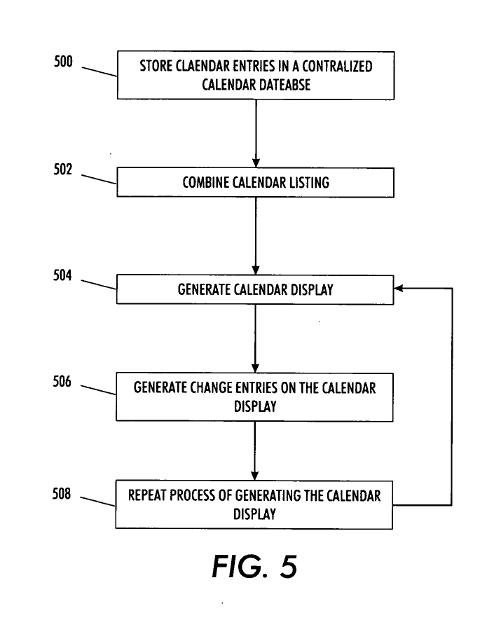

FIG. 5 illustrates the method for generating an electronic calendar in flowchart form. In item 500, the method stores calendar entries for a plurality of entities in a centralized calendar database. As explained above, the calendar entries are stored only in the centralized calendar database, and are not stored in each of the separate computing devices.

In addition, in item 502 a combined calendar listing of entities whose calendar entries are to be combined on each the calendar display is maintained. This process maintains a separate combined calendar listing for each of the entities, such that each calendar generator generates a unique calendar display based on each combined calendar listing on each graphic user interface.

In item 504, the calendar display is generated for an entity on a corresponding graphic user interface using a corresponding calendar processor. Again, this produces a single calendar grid simultaneously showing calendar entries associated with different entities. The calendar entries can be displayed on the calendar display using different graphical representations for calendar entries associated with different entities.

In item 506, change entries are generated on the calendar display. The change entries comprise an area on the calendar display where a previously scheduled calendar entry was positioned before the previously scheduled calendar entry was modified.

Processing continues with item 508 which repeats the process of generating the calendar display by looping back to item 504. The process can be repeated periodically or whenever requested by an entity. Alternatively, different repetition cycles can be established. For example, the centralized calendar database can initiate a repeat 508 cycle each time the database is updated.

As shown above, embodiments herein display calendar events from multiple calendars in one user customized and defined calendar display. This system described above can be used, for example, with a personal homepage system. When the user visits their personal homepage and are either manually or automatically logged in, their stored calendar preferences are provided to the computing device 108 which retrieves the calendar entries 104 from the centralized calendar database 102 in order to create the calendar display on the graphic user interface 1 10. With the embodiments described herein, users no longer need to copy events onto their personal calendar, but instead merely view events that are maintained within the centralized calendar database. This allows individuals to easily integrate information from many sources including, for example, family activities, project activities, workgroup activities, department activities, company activities, a flight itinerary calendar, a hotel itinerary calendar, etc.

Further, the centralized calendar database can be utilized to exchange information between otherwise non-compatible calendaring programs. With the embodiments described herein, so long as a calendaring program can access the information within the centralized calendar database (which can be provided to each individual computing device in a different format) the different calendaring programs can share calendar entries through the centralized calendar database, without having to be compatible with each other.

Thus, as shown above, with embodiments herein, remote computing devices are in constant communication with a centralized calendar database, which maintains all the entries for all calendars. This prevents the loss and inconvenience that occurs when a calendar is not up to date. Instead of storing individual calendars on each of the remote computing devices and performing elaborate and complicated updating procedures to keep all the individual calendars current, embodiments herein generate (and continuously dynamically regenerate) a completely new calendar on each of the remote computing devices based upon the entries stored in the centralized calendar database. This allows each entity to view a single calendar that includes the owning entities calendar entries, as well as calendar entries that are associated with a selected group of other entities. Further, because the calendar entries are only stored within the centralized calendar database, and because the calendar is being continuously dynamically regenerated by each of the remote computing devices (which are in constant communication with the centralized calendar database) the calendar display produced by embodiments herein is always current. Thus, embodiments discussed herein avoid the need for complicated and elaborate mechanisms that were conventionally required to coordinate individually maintained separate calendars.

While the foregoing has been described in conjunction with various exemplary embodiments, it is to be understood that many alternatives, modifications and variations would be apparent to those skilled in the art. Accordingly, Applicants intend to embrace all such alternatives, modifications and variations that follow in this spirit and scope.

What is claimed is:

1. An electronic calendar system comprising:
a centralized calendar database adapted to store calendar entries for a plurality of entities, wherein each of said entities has a computing device separate from said centralized calendar database, and each said computing device has a graphic user interface; and
a plurality of calendar processors, each calendar processor operating within an associated computing device, and each said calendar processor being in communication with said centralized calendar database,
wherein each said calendar processor is adapted to generate a calendar display on a corresponding graphic user interface,
wherein said calendar entries are stored only in said centralized calendar database, and
wherein said calendar generator is adapted to combine calendar entries associated with at least two of said entities on said calendar display.

2. The electronic calendar system according to claim 1, wherein said calendar entries are displayed on said calendar display using different graphical representations for calendar entries associated with different entities.

3. The electronic calendar system according to claim 2, wherein said different graphical representations include different colors, different letter sizes, different letter types, and different typefaces.

4. The electronic calendar system according to claim 1, further comprising at least one storage device operatively connected to each said computing device, wherein said storage device is adapted to maintain a combined calendar listing of entities whose calendar entries are to be combined on each said calendar display.

5. The electronic calendar system according to claim 4, wherein said storage device maintains a separate combined calendar listing for each of said entities, such that each calendar generator generates a unique calendar display based on each said combined calendar listing on each said graphic user interface.

6. The electronic calendar system according to claim 1, wherein said calendar display comprises a single calendar grid simultaneously showing calendar entries associated with different entities.

7. The electronic calendar system according to claim 1, wherein said calendar entries are not stored locally within said computing device.

8. An electronic calendar system comprising:
a centralized calendar database adapted to store calendar entries for a plurality of entities, wherein each of said entities has a computing device separate from said centralized calendar database, and each said computing device has a graphic user interface;
a plurality of calendar processors, each calendar processor operating within an associated computing device, and each said calendar processor being in communication with said centralized calendar database,
wherein each said calendar processor is adapted to generate a continuously updated calendar display on a corresponding graphic user interface,
wherein said calendar entries are stored only in said centralized calendar database,
wherein said calendar generator is adapted to combine calendar entries associated with at least two of said entities on said calendar display, and
wherein said calendar generator is adapted to generate change entries on said calendar display, wherein said change entries comprise an area on said calendar display were a previously scheduled calendar entry was positioned before said previously scheduled calendar entry was modified.

9. The electronic calendar system according to claim 8, wherein said calendar entries are displayed on said calendar display using different graphical representations for calendar entries associated with different entities.

10. The electronic calendar system according to claim 9, wherein said different graphical representations include different colors, different letter sizes, different letter types, and different typefaces.

11. The electronic calendar system according to claim 8, further comprising at least one storage device operatively connected to each said computing device, wherein said storage device is adapted to maintain a combined calendar listing of entities whose calendar entries are to be combined on each said calendar display.

12. The electronic calendar system according to claim 11, wherein said storage device maintains a separate combined calendar listing for each of said entities, such that each calendar generator generates a unique calendar display based on each said combined calendar listing on each said graphic user interface.

13. The electronic calendar system according to claim 8, wherein said calendar display comprises a single calendar grid simultaneously showing calendar entries associated with different entities.

14. The electronic calendar system according to claim 8, wherein said calendar entries are not stored locally within said computing device.

15. A method for generating an electronic calendar, said method comprising:
storing calendar entries for a plurality of entities in a centralized calendar database, wherein each of said entities has a computing device separate from said centralized calendar database, and each said computing device has a graphic user interface and a calendar processor;
generating a calendar display for an entity on a corresponding graphic user interface using a corresponding calendar processor, wherein said calendar entries are stored only in said centralized calendar database, and
wherein said generating of said calendar display comprises combining calendar entries associated with at least two of said entities on said calendar display.

16. The method according to claim 15, wherein during said combining of said calendar entries, said calendar entries are displayed on said calendar display using different graphical representations for calendar entries associated with different entities.

17. The method according to claim 15, wherein said generating of said calendar display further comprises generating change entries on said calendar display, wherein said change entries comprise an area on said calendar display where a previously scheduled calendar entry was positioned before said previously scheduled calendar entry was modified.

18. The method according to claim 15, further comprising maintaining a combined calendar listing of entities whose calendar entries are to be combined on each said calendar display.

19. The method according to claim 18, wherein said maintaining of said combining the calendar listing comprises maintaining a separate combined calendar listing for each of said entities, such that each calendar generator generates a unique calendar display based on each said combined calendar listing on each said graphic user interface.

20. The method according to claim 15, wherein said generating of said calendar display comprises generating a single calendar grid simultaneously showing calendar entries associated with different entities.
